(19) United States
(12) Patent Application Publication
(10) Pub. No.: US 2021/0231030 A1
(43) Pub. Date: Jul. 29, 2021

(54) STEAM BYPASS CONDUIT

(71) Applicant: Siemens Energy Global GmbH & Co. KG, München, Bayern (DE)

(72) Inventors: Christian Musch, Mulheim an der Ruhr (DE); Andreas Auge, Essen (DE); Simon Hecker, Recklinghausen (DE); Stephan Minuth, Mülheim a.d. Ruhr (DE); Andreas Penkner, Mülheim an der Ruhr (DE); Steffen Wendt, Frankfurt (DE)

(73) Assignee: Siemens Energy Global GmbH & Co. KG, München, Bayern (DE)

(21) Appl. No.: 17/257,122

(22) PCT Filed: Jun. 19, 2019
(86) PCT No.: PCT/EP2019/066192

§ 371 Date: Dec. 30, 2020

(30) Foreign Application Priority Data
Jul. 3, 2018 (EP) 18181414.6

(51) Int. Cl. F01K 11/02; F01K 9/04; F28B 9/02

(52) U.S. Cl. CPC F01K 11/02; F05D 2220/31; F28B 9/02; F01K 9/04

(57) ABSTRACT

An arrangement for making a flow uniform, having a housing, which is designed to limit the flow, wherein the housing has holes through which the flow flows, as a jet, into a space outside the housing, wherein the holes are spaced apart in such a way that it is not possible for jets coming from two adjacent holes to merge.

### CROSS REFERENCE TO RELATED APPLICATIONS

This application is the US National Stage of International Application No. PCT/EP2019/066192 filed 19 Jun. 2019, and claims the benefit thereof. The International Application claims the benefit of European Application No. EP18181414 filed 3 Jul. 2018. All of the applications are incorporated by reference herein in their entirety.

### FIELD OF INVENTION

The invention relates to a steam bypass housing for introducing a flow of high-energy steam into a condenser, comprising the arrangement for making the flow uniform, an arrangement having a housing designed to limit the flow, wherein the housing has holes, through which the flow flows as a jet into a space outside the housing.

### BACKGROUND OF INVENTION

In steam turbine systems, steam is generated in a so-called steam generator and conducted via pipelines to a steam turbine. The thermal energy of the steam is converted into mechanical rotational energy in the steam turbine. The pressure and temperature of the steam are hereby reduced. After the steam has flowed through the steam turbine, the steam flows at a comparatively low temperature and low pressure into a condenser, wherein the steam condenses on cool condenser pipelines there, and is converted into water again.

Operating methods such as, for example, bypass operation are known where the high-energy steam is conducted directly into the condenser. This means that the high-energy steam, which is characterized by a high temperature and high pressure, flows directly into the condenser. Therefore, particular precautions are necessary in order that no damage occurs in the condenser. It can occur that, on account of post-expansion of the steam in the condenser, which is also associated with a widening of the jet, downstream of the steam bypass conduit leads to a supersonic or, depending on the gradient, to a locally hypersonic flow field. The velocity of the steam depends on the pressures in the condenser and in the steam bypass conduit. The higher the pressure ratio between the condenser and the pressure in the steam bypass conduit, the higher the maximum flow velocity.

In bypass operation, three criteria must be fulfilled substantially in order that safe operation is possible which, furthermore, leads as far as possible to little damage. These would be firstly the criterion that the steam is supplied to the condenser without the rotor having steam applied actively thereto or being driven. Secondly, the steam bypass conduit must be configured such that it does not damage the cooling pipes of the condenser by the imposition of impermissibly high steam velocities. Finally, the following criterion must be observed: since the steam is cooled by water injection before the introduction into the condenser, and the water may be present in the form of droplets or wet steam, it must additionally be ensured that erosion damage in the condenser and turbine does not occur as a result of droplet loading.

The aforementioned criteria thus lead to a design of the steam conduit which supplies bypass steam to the condenser at a given condenser pressure with the lowest possible flow velocity with controlled steam guidance and does not have a detrimental influence on the integrity of turbine and condenser.

It is therefore known to supply the bypass steam to the condenser by flowing through a perforated basket. A perforated basket is characterized by a housing which has individual holes through which the bypass steam flows. After the perforated basket, the steam flows into a free space of the condenser dome, which is frequently provided with reinforcing elements of different geometry.

One alternative to the perforated basket is represented by so-called dump tubes. These are also designed to conduct the bypass steam into the condenser. The dump tube is characterized by a tube-like housing, which likewise has holes through which the bypass steam flows into the condenser.

However, in both arrangements (perforated basket and dump tube), it must be ensured that the steam neither flows directly in the direction of the condenser pipes nor in the direction of the turbine, in order to prevent any damage to the condenser pipework and turbine blades.

One problem is represented by the erosion. Since, because of the gas-dynamically induced jet bursting, it is possible for a large area with ultrasonic flow to occur, it is not always possible to completely rule out erosion-induced damage in the condenser. The erosion arises in that water droplets are accelerated to high velocity and then strike installed fittings. Although this damage can be minimized by the use of erosion-resistant materials, this is very costly and, in the event of service later, can lead to renewal thereof.

The previous configurations of the perforated basket and the dump tubes are such that post-expansion occurs, in which merging of the jets from the individual holes, which can be designated throttling holes, leads to a large coherent region with ultrasonic flow, in which the risk of damage potentially exists. Since dissipation of the jet takes place substantially only at the edge of the jet, in this case the penetration depth of the jet is also very high. In the case of a perforated basket, this region can reach as far as the opposite condenser wall. Here the invention wishes to devise a remedy.

### SUMMARY OF INVENTION

It is an object of the invention to specify a bypass steam system having an arrangement in which the danger of erosion is minimized.

This is carried out by means of an optimal arrangement of the holes, with which it is possible to avoid the merging of the individual jets.

As a result, the area in which the jet energy is dissipated is enlarged by many times and thus the penetration depth is reduced by many times.

The object is therefore achieved by a steam bypass system for introducing a flow of high-energy steam into a condenser, comprising an arrangement for making the flow uniform, wherein the arrangement has a housing which is designed to limit the flow, wherein the housing has holes through which the flow flows as a jet into a space outside the housing, wherein the spacing D of the holes is such that, at a distance A from the housing, it is not possible for the jets coming from two adjacent holes to merge, wherein D=A, wherein the spacing D of two adjacent hole centers is at least D=50 mm.

In one case, the arrangement is a perforated basket and, in another case, a dump tube. The spacing D of two adjacent hole centers is at least 50 mm. This is a value which has been determined empirically and represents an optimum value. With this value of 50 mm, the spacing between the individual holes is such that the hole pattern is of a type in which jet merging cannot occur at any operating point.

As a result, the danger of erosion is minimized.

Advantageous developments are specified in the sub-claims.

Thus, a first advantageous development is provided by the fact that the holes are designed as a hole differing from a circular cross section. Here, the ratio of hole circumference to hole cross section should be maximized in order that the jet edge is also maximized.

In an advantageous development, the hole can be formed in the shape of a cloverleaf. With such a shape, the ratio of hole circumference to hole cross section is a maximum and leads to a further improvement.

In a further advantageous development, according to the invention the holes are designed in the shape of a Laval nozzle. This achieves the situation in which the expansion into the ultrasound does not take place in an uncontrolled or unguided manner after the hole. In a Laval nozzle, controlled expansion to the condenser pressure takes place. As a result, the bursting of the jet can be avoided, and the maximum diameter of the jet can be reduced thereby. As a result, the minimum spacing to be maintained between the holes can be reduced, and thus also the total space required can be reduced.

The above-described properties, features and advantages of this invention and the manner in which this is achieved will become clearer and considerably more comprehensible in conjunction with the following description of the exemplary embodiments, which will be explained in more detail in conjunction with the drawings.

The same components or components with the same function are identified by the same designations.

Exemplary embodiments of the invention will be described below by using the drawings. These are not intended to illustrate exemplary embodiments to scale; instead the drawings, where helpful for the explanation, are laid out in a schematic and/or slightly distorted form. With regard to extensions of the teaching that can be seen directly in the drawings, reference is made to the relevant prior art.

### BRIEF DESCRIPTION OF THE DRAWINGS

In the figures:

FIG. 1 shows a perspective illustration of a part of a condenser.

FIG. 2 shows an enlarged illustration of a part from FIG. 1.

FIG. 3 shows a schematic illustration of an alternative embodiment of the arrangement.

FIG. 4 shows an enlarged illustration of an arrangement according to the invention.

FIG. 5 shows a perspective illustration of a part of the arrangement.

FIG. 6 shows a perspective illustration of an alternative embodiment of a part of the arrangement.

FIG. 7 shows a cross-sectional view of a part of the arrangement.

FIG. 8 shows a plan view of a part of the arrangement.

### DETAILED DESCRIPTION OF INVENTION

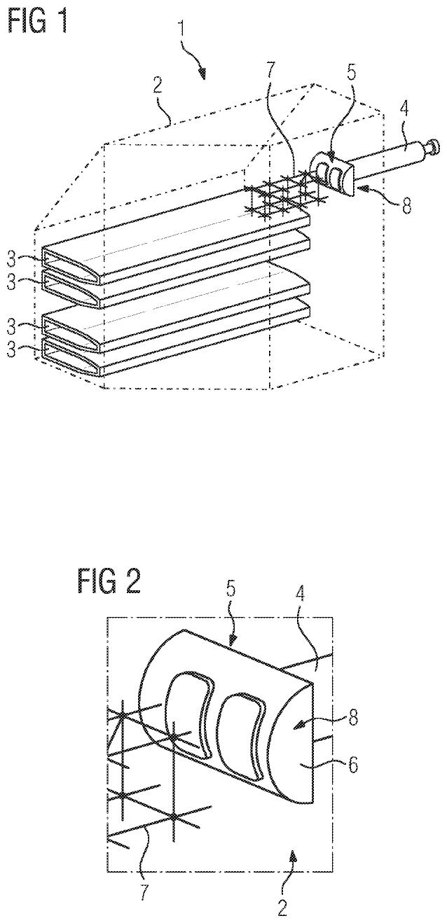

FIG. 1 shows a condenser 1. The condenser 1 comprises a condenser housing 2 and condenser pipes 3. A cooling medium flows through the condenser pipes 3. On the surface of the condenser pipes 3, the steam supplied in the condenser housing 2 from a low-pressure part turbine condenses to form water. The supply of the steam from the low-pressure part turbine into the condenser 1 is not illustrated in detail in FIG. 1.

In bypass operation, steam with high energy flows via a bypass steam system via a bypass line 4 through the condenser housing 2 in an arrangement 5 which, in this case, is a perforated basket 6. Reinforcing elements 7 are arranged within the condenser 1. The arrangement 5 comprises a housing 8 which is designed to limit the flow from the bypass line 4.

The housing 8 has holes 9. The arrangement 5 and the housing 8 are formed in such a way that the steam from the bypass line 4 can flow into the condenser interior only through the holes 9, and it is not possible for the steam to flow out between the housing 8 and condenser housing 2.

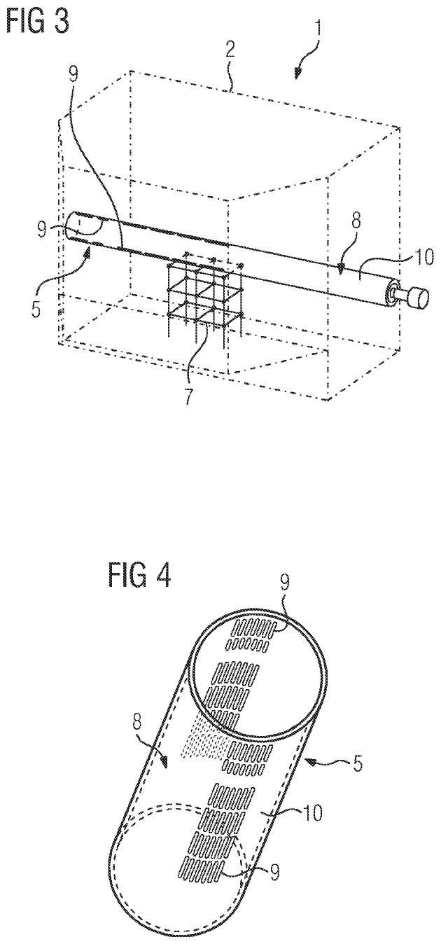

FIG. 3 shows an alternative embodiment of the arrangement 5. In the embodiment illustrated in FIG. 3, the arrangement 5 is formed as a dump tube 10. The dump tube 10 likewise has a housing 8 in which holes 9 are arranged.

FIG. 6 shows an enlarged illustration of a part of the arrangement, which can be formed as a perforated basket 6 or as a dump tube 10. In FIG. 6, it is possible to see a part of the housing 8. Further, multiple holes 9 are shown. The hole centers 13 of two adjacent holes 9 have a spacing 11 from one another. This spacing 11 is such that a jet flowing through the hole 9 does not merge with another. The spacing 11 should therefore be at least 50 mm.

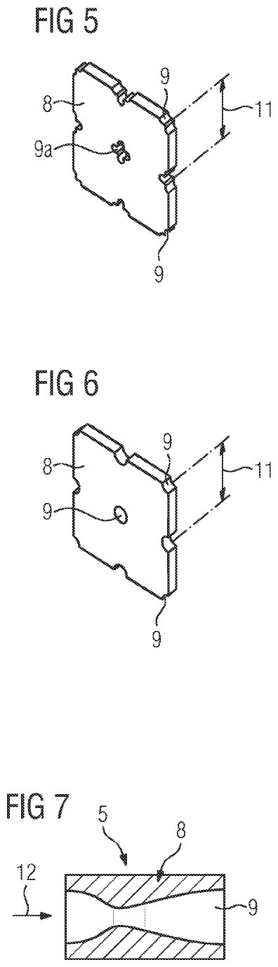

FIG. 5 shows an alternative embodiment of a hole 9a. The hole 9a is designed as a cloverleaf. The ratio of hole circumference and hole cross section is optimal.

FIG. 7 shows an embodiment of a hole 9. Here, the hole is designed as a Laval nozzle. The flow 12 takes place from left to right.

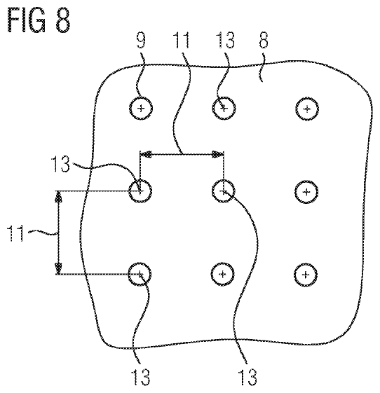

FIG. 8 shows an illustration of the spacing 11 of two adjacent holes 9. The hole centre 13 is identified by a cross. For reasons of clarity, only four hole centers are provided with the designation 13.

1. A bypass steam system for introducing a flow of high-energy steam into a condenser, comprising:
an arrangement making the flow uniform, wherein the arrangement has a housing, which is designed to limit the flow, wherein the housing has holes, through which the flow flows as a jet into a space outside the housing,
wherein the spacing D of the holes is such that, at a distance A from the housing, it is not possible for jets coming from two adjacent holes to merge, where D=A,
wherein the spacing D of two adjacent hole centers is at least D=50 mm.

2. The arrangement as claimed in claim 1,
wherein the arrangement is a perforated basket.

3. The arrangement as claimed in claim 1,
when the arrangement is a dump tube.

4. The arrangement as claimed in claim 1,
wherein the holes are formed as a hole differing from a circular cross section.

5. The arrangement as claimed in claim 4,
wherein the ratio of hole circumference to hole cross section is maximized.

6. The arrangement as claimed in claim 4,
wherein the hole is formed in the shape of a cloverleaf.

7. The arrangement as claimed in claim 1,
wherein the holes are designed in the shape of a Laval nozzle.

8. A condenser comprising:
an arrangement as claimed in claim 1.
